(19) United States
(12) Patent Application Publication
(10) Pub. No.: US 2025/0125518 A1
(43) Pub. Date: Apr. 17, 2025

(54) SENSOR DEVICE AND IMAGE DISPLAY DEVICE INCLUDING THE SAME

(71) Applicant: DONGWOO FINE-CHEM CO., LTD., Jeollabuk-do (KR)

(72) Inventors: DO HYOUNG KWON, Jeollabuk-do (KR); BYUNG JIN CHOI, Jeollabuk-do (KR); YOON HO HUH, Jeollabuk-do (KR)

(21) Appl. No.: 18/911,407

(22) Filed: Oct. 10, 2024

(30) Foreign Application Priority Data
Oct. 12, 2023 (KR) 10-2023-0135976

(51) Int. Cl. H01Q 1/22; G06F 1/16; H01Q 1/24

(52) U.S. Cl. CPC H01Q 1/2283; G06F 1/1683; H01Q 1/2266; H01Q 1/241

(57) ABSTRACT

A sensor device includes sensing electrodes, traces connected to the sensing electrodes, an antenna unit including a radiator and a signal pad, and a circuit board including a core layer, a first signal wiring disposed on one surface of the core layer and bonded to the signal pad, a second signal wiring disposed on the other surface of the core layer, and a via structure which penetrates the core layer to electrically connect the first signal wiring and the second signal wiring. The via structure is disposed between the signal pad and the traces in a planar direction. The signal wiring of the circuit board and the traces may be sufficiently spaced apart from each other to suppress signal interference therebetween.

### CROSS-REFERENCE TO RELATED APPLICATION AND CLAIM OF PRIORITY

This application claims the benefit under 35 USC § 119 of Korean Patent Application No. 10-2023-0135976 filed on Oct. 12, 2023, in the Korean Intellectual Property Office, the entire disclosure of which is incorporated herein by reference for all purposes.

### BACKGROUND

### 1. Technical Field

The present invention relates to a sensor device and an image display device including the sensor device.

### 2. Background Art

Recently, according to development of the information-oriented society, wireless communication techniques such as Wi-Fi, Bluetooth, and the like are implemented, for example, in a form of smartphones by combining with image display devices. In this case, an antenna may be coupled to the image display device to perform a communication function.

Recently, with mobile communication techniques becoming more advanced, an antenna for performing high frequency or ultra-high frequency communication corresponding to 3G to 5G or higher, for example, may be coupled to the image display device.

Meanwhile, electronic devices, in which a touch panel or a touch sensor as an input device for allowing a user to select instructions displayed on a screen by his or her finger or an object such as a touch pen and input his or her command is coupled with the image display device to implement an image display function and an information input function together, have been developed. For example, as disclosed in Korean Patent Laid-Open Publication No. 2014-0092366, a touch screen panel, in which a touch sensor is coupled to various image display devices, has been developed.

When mounting an antenna structure and touch sensing electrodes together within a limited size and design of the image display device, gain characteristics of the antenna may be reduced due to mutual signal interference, and a resolution of the touch sensor may also be deteriorated.

For example, Korean Patent Laid-Open Publication No. 2003-0095557 discloses an antenna structure built into a portable terminal, but it fails to consider consistency with other electrical devices such as a touch sensor.

### SUMMARY

An object of the present invention is to provide a sensor device having improved reliability and efficiency of signal transmission and reception.

Another object of the present invention is to provide an image display device including the sensor device having improved reliability and efficiency of signal transmission and reception.

To achieve the above objects, the following technical solutions are adopted in the present invention.

1. A sensor device including: sensing electrodes; traces which are connected to the sensing electrodes; an antenna unit which includes a radiator and a signal pad; and a circuit board, wherein the circuit board includes a core layer, a first signal wiring disposed on one surface of the core layer and bonded to the signal pad, a second signal wiring disposed on the other surface of the core layer, and a via structure which penetrates the core layer to electrically connect the first signal wiring and the second signal wiring, wherein the via structure is disposed between the signal pad and the traces in a planar direction.

2. The sensor device according to the above 1, wherein the sensing electrodes include first sensing electrodes arranged in a column direction, and second sensing electrodes arranged in a row direction.

3. The sensor device according to the above 2, wherein the sensing electrodes include a plurality of first sensing electrode columns each including first sensing electrodes, and the traces include column traces connected to each of the plurality of first sensing electrode columns.

4. The sensor device according to the above 3, wherein the plurality of first sensing electrode columns include: an antenna-sensing electrode column including a recess of a shape into which the radiator is inserted; and a base sensing electrode column except for the antenna-sensing electrode column. 5. The sensor device according to the above 4, wherein the recess is formed at one end of the antenna-sensing electrode column, and the column traces extend from the other end of the antenna-sensing electrode column.

6. The sensor device according to the above 5, wherein the column traces include a first column trace extending from the other end of the antenna-sensing electrode column, and a second column trace extending from one end of the base sensing electrode column, and the other end of the antenna-sensing electrode column faces the one end of the base sensing electrode column in the column direction.

7. The sensor device according to the above 2, wherein the sensing electrodes include a plurality of second sensing electrode rows each including second sensing electrodes, and the traces include row traces connected to each of the plurality of second sensing electrode rows.

8. The sensor device according to the above 7, wherein the row traces include a first row trace extending from one end of the second sensing electrode row, and a second row trace extending from the other end of the second sensing electrode row.

9. The sensor device according to the above 1, wherein the sensing electrodes and the antenna unit are disposed in the same layer.

10. The sensor device according to the above 1, wherein the antenna unit and the traces are disposed in the same layer.

11. The sensor device according to the above 1, wherein the antenna unit further includes a transmission line which connects the radiator and the signal pad.

12. The sensor device according to the above 1, wherein the second signal wiring and the traces are spaced apart from each other in a thickness direction with the core layer interposed therebetween.

13. The sensor device according to the above 1, further including touch sensor pads which are connected to one end of each of the traces, and the other end of each of the traces is connected to the sensing electrodes.

14. An image display device including: a display panel; and the above-described sensor device, which is arranged in the display panel.

According to embodiments of the present invention, the radiator and the sensing electrodes are disposed together in the active area of the sensor device, such that the space efficiency may be improved.

In exemplary embodiments, the first signal wiring bonded to the antenna unit through then via structure of the circuit board and the second signal wiring disposed at a different level from the first signal wiring may be connected. The via structure may be disposed between the signal pad of the antenna unit and the traces in the planar direction. Accordingly, signals of the antenna unit may be transmitted through the traces and the second signal wiring spaced apart from each other in the thickness direction with the core layer of the circuit board interposed therebetween. Accordingly, interference or disturbance between the sensing signal transmitted through the traces and the antenna signal transmitted through the signal wirings may be prevented.

### BRIEF DESCRIPTION OF THE DRAWINGS

The above and other objects, features and other advantages of the present invention will be more clearly understood from the following detailed description taken in conjunction with the accompanying drawings, in which:

FIGS. 1 and 2 are a schematic plan view and a cross-sectional view illustrating a sensor device according to exemplary embodiments, respectively; and

FIGS. 3 and 4 are a schematic plan view and a cross-sectional view illustrating an image display device according to exemplary embodiments, respectively.

### DETAILED DESCRIPTION

Embodiments of the present invention provide a sensor device including an antenna unit and sensing electrodes. In addition, there is provided an image display device including the sensor device.

The antenna unit may be, for example, a microstrip patch antenna manufactured in the form of a transparent film. The sensor device including the antenna unit may be applied to, for example, a communication device for high frequency or ultra-high frequency (e.g., 3G, 4G, 5G or higher) mobile communication. However, the use of the sensor device is not limited only to the image display device, and the sensor device may be applied to various structures such as a vehicle, a home appliance, a building and the like.

Hereinafter, preferred embodiments of the present invention will be described in detail with reference to the accompanying drawings. However, since the drawings attached to the present disclosure are only given for illustrating one of several preferred embodiments of present invention to easily understand the technical spirit of the present invention with the above-described invention, it should not be construed as limited to such a description illustrated in the drawings.

The terms “first,” “second,” “one surface,” “the other surface,” “one end,” “the other end,” “upper side,” “lower side,” “upper portion,” “lower portion,” “column direction,” “row direction,” and the like as used herein do not limit the absolute position or order, but are used in a relative sense to distinguish different components or portions.

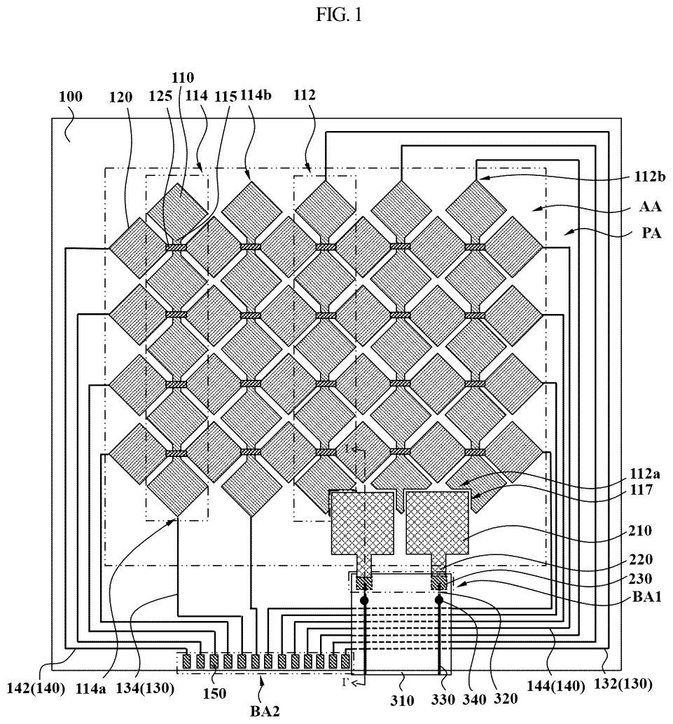

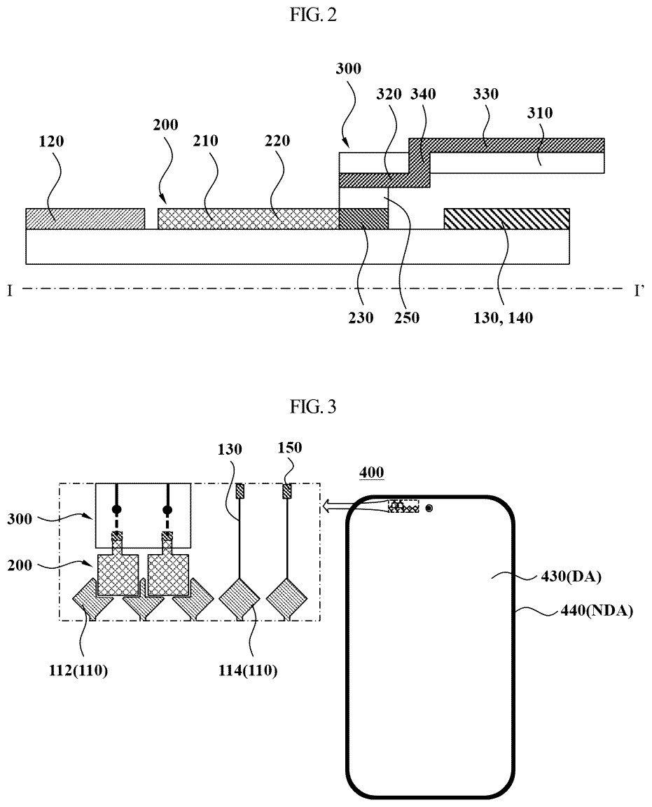

FIGS. 1 and 2 are a schematic plan view and a cross-sectional view illustrating a sensor device according to exemplary embodiments, respectively. For example, FIG. 2 is a cross-sectional view taken on line I-I′ of FIG. 1 in a thickness direction.

Referring to FIGS. 1 and 2, the sensor device may include a substrate layer 100, sensing electrodes 110 and 120, traces 130 and 140, and an antenna unit 200 which are disposed on the substrate layer 100. The antenna unit 200 may include a radiator 210 and a signal pad 230.

The substrate layer 100 may include a support layer, an interlayer insulation layer or a film type substrate for forming the sensing electrodes 110 and 120, the traces 130 and 140 and the antenna unit 200. For example, the substrate layer 100 may also be provided as a dielectric layer of the antenna unit 200.

For example, the substrate layer 100 may include a transparent resin film including a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acrylic resin such as polymethyl (meth)acrylate, polyethyl (meth)acrylate, etc.; a styrene resin such as polystyrene, acrylonitrile-styrene copolymer, etc.; a polyolefin resin such as polyethylene, polypropylene, cyclic polyolefin or polyolefin having a norbornene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; an epoxy resin; a urethane or acrylic urethane resin, a silicone resin and the like. These may be used alone or in combination of two or more thereof.

In some embodiments, the substrate layer 100 may include an adhesive film, such as an optically clear adhesive (OCA), an optically clear resin (OCR) and the like.

In some embodiments, the substrate layer 100 may include an inorganic insulation material such as a silicon oxide, silicon nitride, silicon oxynitride, glass and the like.

In one embodiment, the substrate layer 100 may be provided as a substantial single layer.

In one embodiment, the substrate layers 100 may each include a multilayer structure of two or more layers. For example, the substrate layer 100 may include a lower substrate and a dielectric layer, and may include an adhesive layer between the lower substrate and the dielectric layer.

An impedance or inductance for the antenna unit 200 is formed by the substrate layer 100, thus to adjust a frequency band which can be driven or sensed by the antenna unit 200. In some embodiments, the dielectric constant of the substrate layer 100 may be adjusted to a range of about 1.5 to 12. When the dielectric constant exceeds about 12, a driving frequency is excessively reduced, such that driving of the antenna in a high frequency band may not be implemented.

In one embodiment, a ground layer (not shown) may be disposed under a lower surface of the substrate layer 100.

In one embodiment, a conductive member of an image display device or display panel to which the sensor device is applied may be provided as the ground layer.

For example, the conductive member may include electrodes or wirings such as a gate electrode, source/drain electrodes, a pixel electrode, a common electrode, a data line, a scan line, and the like included in a thin film transistor (TFT) array panel.

In one embodiment, a metallic member such as a stainless steel (SUS) plate, a sensor member such as a digitizer, a heat radiation sheet, etc., disposed on a back portion of the image display device may be provided as the ground layer.

The substrate layer 100 may include, on an upper surface thereof, an active area AA where the sensing electrodes 110 and 120 and the radiator 210 are driven, and a peripheral area PA where the traces 130 and 140, the signal pad 230 and the touch sensor pad 150 are disposed. For example, the peripheral area PA may be defined as an area surrounding the periphery of the active area AA. For example, the peripheral area PA may be defined as an area which surrounds the periphery of the active area AA.

In exemplary embodiments, the sensing electrodes 110 and 120 may include first sensing electrodes 110 arranged in a column direction and second sensing electrodes 120 arranged in a row direction. For example, the first sensing electrodes 110 and the second sensing electrodes 120 may be arranged in a direction intersecting each other. In one embodiment, the first sensing electrodes 110 and the second sensing electrodes 120 may be arranged in the same layer.

The term “column direction” as used herein may refer to a longitudinal direction of the sensor device and/or a core layer 310.

The term “row direction” as used herein may refer to a width direction of the sensor device and/or the core layer 310.

In some embodiments, the first sensing electrodes 110 may be connected with each other in the column direction through a connection part 115. The connection part 115 may be integrally connected with the first sensing electrodes 110 to be formed as a substantial single member with the first sensing electrodes 110.

In some embodiments, the sensing electrodes 110 may include a plurality of first sensing electrode columns each including first sensing electrodes 110. For example, a plurality of first sensing electrodes 110 may be connected with each other through the connection parts 115 to define a first sensing electrode column extending in the column direction. For example, the plurality of first sensing electrode columns may be arranged in the row direction.

In some embodiments, each of the second sensing electrodes 120 may have an island pattern shape in which they are spaced apart from each other. The second sensing electrodes 120 adjacent in the row direction may be electrically connected with each other by a bridge electrode 125. For example, a pair of second sensing electrodes 120 adjacent to each other with the connection part 115 interposed therebetween may be electrically connected by the bridge electrode 125.

In some embodiments, the sensing electrodes 120 may include a plurality of second sensing electrode rows each including second sensing electrodes 120. For example, a plurality of second sensing electrodes 120 may be connected with each other through the bridge electrodes 125 to define a second sensing electrode row extending in the row direction. For example, the plurality of second sensing electrode rows may be arranged in the column direction.

For example, an insulation layer which covers the sensing electrodes 110 and 120 may be formed, and the bridge electrode 125 may penetrate the insulation layer to connect the adjacent second sensing electrodes 120. For example, the bridge electrode 125 may be formed in a different layer from the sensing electrodes 110 and 120.

The first sensing electrodes 110 and the second sensing electrodes 120 may be provided together as touch sensors. The position and sensitivity of a touch are sensed by the first sensing electrode columns and the second sensing electrode rows, and may be converted into an electrical signal to be transmitted to a touch sensor driving IC chip.

In FIG. 1, it is illustrated that each of the sensing electrodes 110 and 120 has a rhombus pattern shape, but the shapes of the sensing electrodes 110 and 120 may be appropriately changed in consideration of the pattern density, consistency with the optical characteristics of the image display device and the like. According to one embodiment, the sensing electrodes 110 and 120 may be formed to have a wavy border.

In FIG. 1, it is illustrated that column-directional sensing electrodes are integrally connected with each other by the connection parts, and row-directional sensing electrodes are connected with each other by the bridge electrodes, however, the column direction and the row direction are used relatively to refer to two other intersecting directions, and it is not intended to limit them to a specific direction.

In addition, the number of the first sensing electrode columns and the second sensing electrode rows shown in FIG. 1, and the number of sensing electrodes included therein are only partially shown for the convenience of description, and may be expanded according to an area of the active area AA.

In exemplary embodiments, the traces 130 and 140 may be connected with the sensing electrodes 110 and 120. For example, the traces 130 and 140 may be branched from the first sensing electrode column and the second sensing electrode row to extend on the peripheral area PA.

The traces 130 and 140 may include column traces 130 connected to each of the plurality of first sensing electrode columns.

In some embodiments, the plurality of first sensing electrode columns may include an antenna-sensing electrode column 112 including a recess 117 of a shape into which the radiator 210 is inserted, and a base sensing electrode column 114 except for the antenna-sensing electrode column 112. Accordingly, the radiator 210 and the sensing electrodes 110 and 120 may be disposed together in the active area AA, thereby improving space efficiency.

For example, the recess 117 may be formed in a shape in which the first sensing electrodes 110 adjacent to the radiator 210 are recessed along upper surface and side edge profiles of the radiator 210. The radiator 210 may be disposed in a form inserted into the recess 117.

For example, the first sensing electrodes 110 adjacent to the radiator 210 and the radiator 210 may be disposed to be spaced apart from each other.

For example, a plurality of antenna units 200 adjacent in the row direction may form an antenna unit array. In FIG. 1, two antenna units 200 are disposed adjacent in the row direction, but two to six antenna units 200 may be disposed to be spaced apart from each other in the row direction. According to one embodiment, four antenna units 200 may be disposed adjacent in the row direction to form an antenna unit array.

In some embodiments, a distance between center points of the radiators 210 adjacent in the row direction may be 80% to 120% of a distance between center points of the first sensing electrodes 110 adjacent in the row direction, and in one embodiment, may be 100%. Accordingly, stable sensing performances and regular radiation patterns may be implemented even with the repeated arrangement of the antenna unit 200 and the sensing electrodes 110 and 120.

In some embodiments, the recess 117 may be formed at one end 112a of the antenna-sensing electrode column 112, and the column traces 130 may be branched and extend from the other end 112b of the antenna-sensing electrode column 112.

In some embodiments, the column traces 130 may include a first column trace 132 extending from the other end 112b of the antenna-sensing electrode column 112, and a second column trace 134 extending from the one end 114a of the base sensing electrode column 114. For example, the other end 112b of the antenna-sensing electrode column 112 may face the one end 114a of the base sensing electrode column 114 in the column direction. Accordingly, signals of the first sensing electrode columns 112 and 114 may be smoothly transmitted and received, while securing a space in which the radiators 210 are disposed in the active area AA.

In one embodiment, the first column trace 132 may extend from an upper portion of the antenna-sensing electrode column 112 and the second column trace 134 may extend from a lower portion of the base sensing electrode column 114.

In some embodiments, the traces 130 and 140 may include row traces 140 connected to each of the plurality of second sensing electrode rows.

In some embodiments, the row traces 140 may include a first row trace 142 extending from one end of the second sensing electrode row, and a second row trace 144 extending from the other end of the second sensing electrode row.

According to one embodiment, the first row trace 142 and the second row trace 144 may be respectively connected to opposite distal ends of one second sensing electrode row. As a result, the second sensing electrode rows may be double-routed, thereby improving sensing performance.

In some embodiments, the antenna unit 200 may include the radiator 210, a signal pad 230, and a transmission line 220 which connects the radiator 210 and the signal pad 230.

For example, the radiator 210 may have a polygonal plate shape.

For example, the transmission line 220 may have a width smaller than that of the radiator 210 and may be connected with one end or one side of the radiator 210. The radiator 210 and the transmission line 220 may be formed as a single member integrally connected with each other.

A target resonance frequency of the antenna unit 200 may be adjusted depending on the shape/size of the radiator 210. For example, the radiator 210 may be designed to radiate radio waves in a high frequency/ultra-high frequency band of 3G, 4G, 5G or higher. For example, a radiation band of a frequency band of about 0.5 GHz or higher, about 1 GHz or higher, about 10 GHz or higher, about 20 GHz or higher, about 30 GHz or higher, or about 40 GHz or higher may be implemented through the radiator 210.

The signal pad 230 may be disposed at a distal end of the transmission line 220. The signal pad 230 may be integrally formed with the transmission line 220 as a substantial single member. In this case, the distal end of the transmission line 220 may also be provided as the signal pad 230.

The sensing electrodes 110 and 120, the traces 130 and 140 and/or the antenna unit 200 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn) or an alloy containing at least one of these. These may be used alone or in combination of two or more.

In one embodiment, the sensing electrodes 110 and 120, the traces 130 and 140, and/or the antenna unit 200 may include silver (Ag) or a silver alloy (e.g., a silver-palladium-copper (APC) alloy), or copper (Cu) or a copper alloy (e.g., a copper-calcium (CuCa) alloy) for implementation of low resistance and fine linewidth.

In some embodiments, the sensing electrodes 110 and 120, the traces 130 and 140, and/or the antenna unit 200 may include a transparent conductive oxide, such as indium tin oxide (ITO), indium zinc oxide (IZO), indium zinc tin oxide (IZTO), or zinc oxide (ZnOx).

In some embodiments, the sensing electrodes 110 and 120, the traces 130 and 140, and/or the antenna unit 200 may include a lamination structure of a transparent conductive oxide layer and a metal layer, for example, a two-layer structure of a transparent conductive oxide layer-metal layer or a three-layer structure of a transparent conductive oxide layer-metal layer-transparent conductive oxide layer. In this case, the flexible characteristic may be enhanced by the metal layer, and the signal transmission speed may be improved by reducing the resistance, as well as the corrosion resistance and transparency may be improved by the transparent conductive oxide layer.

The sensing electrodes 110 and 120, the traces 130 and 140, and/or the antenna unit 200 may include a blackening treated part. Accordingly, the reflectivity on the surfaces of the sensing electrodes 110 and 120, the traces 130 and 140, and/or the antenna unit 200 may be reduced, thereby decreasing pattern visibility due to light reflection.

In one embodiment, the surfaces of the metal layer included in the sensing electrodes 110 and 120, the traces 130 and 140, and/or the antenna unit 200 may be converted into a metal oxide or metal sulfide to form a blackening layer. In one embodiment, blackening layer(s) such as a black material coating layer or a plating layer may be formed on the sensing electrodes 110 and 120, the traces 130 and 140, and/or the antenna unit 200 or the metal layer. The black material or plating layer may include an oxide, sulfide, alloy, or the like containing silicon, carbon, copper, molybdenum, tin, chromium, molybdenum, nickel, cobalt, or at least one of these.

The composition and thickness of the blackening layer may be adjusted considering the reflectivity reduction effect and antenna radiation characteristics.

In one embodiment, the sensing electrodes 110 and 120 and the radiator 210 may include a mesh structure. Accordingly, it is possible to suppress the sensing electrodes 110 and 120 and the radiator 210 from being viewed by a user in the active area AA.

In one embodiment, at least a portion of the transmission line 220 and the signal pad 230 may include a solid structure. Accordingly, an increase in the resistance due to bonding at a connection part between the antenna unit 200 and a circuit board 300 may be suppressed, and power supply efficiency may be improved.

In one embodiment, the sensing electrodes 110 and 120 and/or the radiator 210 may include a solid structure. Accordingly, the sensing sensitivity and the emission performance may be improved.

In some embodiments, the sensing electrodes 110 and 120 and the antenna unit 200 may be formed in the same layer. For example, the sensing electrodes 110 and 120 and the radiator 210 may be patterned in the same layer to have a mesh structure. Accordingly, the process may be simplified and the connection reliability of the sensing electrodes 110 and 120 and the radiator 210 may be improved.

In some embodiments, the antenna unit 200 and the traces 130 and 140 may be formed in the same layer. For example, when the sensing electrodes 110 and 120 include a transparent conductive oxide and the bridge electrode 125 includes a transparent conductive oxide or metal, the antenna unit 200, the traces 130 and 140, and the bridge electrode 125 may be patterned in the same layer. Accordingly, the process may be simplified.

For example, the circuit board 300 and the antenna unit 200 may be electrically connected with each other through the signal pad 230. The signal pad 230 may be disposed in a first bonding area BA1 where the circuit board 300 and the antenna unit 200 are bonded.

In exemplary embodiments, the circuit board 300 may include the core layer 310, a first signal wiring 320 disposed on one surface of the core layer 310, and a second signal wiring 330 disposed on the other surface of the core layer 310. In one embodiment, the circuit board 300 may include a flexible printed circuit board (FPCB).

For example, the core layer 310 may include a flexible resin such as a polyimide resin, a modified polyimide (MPI), an epoxy resin, a polyester, a cycloolefin polymer (COP), a liquid crystal polymer (LCP) and the like. In one embodiment, the core layer 310 may include the polyimide resin or MPI.

The first signal wiring 320 may be bonded to the signal pad 230 of the antenna unit 200 in the first bonding area BA1. For example, one end of the first signal wiring 320 may be bonded to the signal pad 230 to connect the radiator 210 and the first signal wiring 320. Accordingly, signal transmission and reception and/or power supply between an antenna driving IC chip of the circuit board 300 and the antenna unit 200 may be performed.

As shown in FIG. 2, the sensor device may further include a conductive relay structure 250 disposed between the signal pad 230 and the circuit board 300 in the first bonding area BA1. For example, the signal pad 230 and the first signal wiring 320 may be bonded/adhered to each other through the conductive relay structure 250. For example, the signal pad 230, the conductive relay structure 250, and the first signal wiring 320 may be sequentially contacted or laminated in the first bonding area BA1.

For example, the conductive relay structure 250 may be bonded together on the signal pad 230. Thereafter, one end of the first signal wiring 320 may be bonded on the signal pad 230 through a heating/pressing process.

In one embodiment, the conductive relay structure 250 may include an anisotropic conductive film (ACF).

In exemplary embodiments, the circuit board 300 may include a via structure 340 which penetrates the core layer 310 to electrically connect the first signal wiring 320 and the second signal wiring 330.

For example, the first signal wiring 320 may extend beneath a lower surface of the core layer 310 and be adjacent to the traces 130 and 140 in the thickness direction. For example, the second signal wiring 330 may extend on an upper surface of the core layer 310 and be spaced apart from the traces 130 and 140 in the thickness direction with the core layer 310 interposed therebetween.

The via structure 340 may be disposed between the signal pad 230 and the traces 130 and 140 in the planar direction. Accordingly, in an area where the circuit board 300 and the traces 130 and 140 are overlapped in the planar direction, a signal of the antenna unit 200 may be transmitted through the second signal wiring 330 which is disposed relatively far from the traces 130 and 140. Accordingly, interference or disturbance between the sensing signal transmitted through the traces 130 and 140 and the antenna signal transmitted through the signal wirings 320 and 330 may be prevented. Accordingly, the stability and driving reliability of the antenna unit 200 and the sensing electrodes 110 and 120 may be improved.

The expression “in the planar direction” as used herein may refer to the case of observing the sensor device ‘in the plan view of the sensor device (e.g., FIG. 1)’ and/or ‘in the top view thereof’.

For example, the via structure 340 may be positioned between the signal pad 230 and the traces 130 and 140 in the column direction when projected onto the same plane as the signal pad 230 and the traces 130 and 140.

For example, when the core layer 310 is projected on the same plane as the signal pad 230 and the traces 130 and 140, a via hole may be formed in an area between the signal pad 230 of the core layer 310 and the traces 130 and 140. The via hole may be filled with the above-described metals and/or materials to form the via structure 340.

The first signal wiring 320, the second signal wiring 330 and the via structure 340 may include the above-described metals and/or alloys thereof.

In one embodiment, the first signal wiring 320, the second signal wiring 330, and the via structure 340 may be integrally formed with each other using substantially the same material.

In some embodiments, the sensor device may further include touch sensor pads 150 connected to one end of each of the traces 130 and 140. The other end of each of the traces 130 and 140 may be connected with the sensing electrodes 110 and 120.

The touch sensor pads 150 may be disposed in a second bonding area BA2. The touch sensor pads 150 may be electrically connected with a touch circuit board (not shown) in the second bonding area BA2. Accordingly, signals detected by the sensing electrodes 110 and 120 may be transmitted to the touch sensor driving IC chip through the traces 130 and 140, the touch sensor pads 150 and the touch circuit board.

For example, the touch circuit board and the touch sensor pads 150 may be connected with each other through the method substantially same as/similar to the method for bonding the circuit board 300 and the signal pad 230.

In some embodiments, the touch circuit board and the circuit board 300 may be connected around the same surface of the substrate layer 100. For example, the touch circuit board and the circuit board 300 may be bonded to a lower portion of the substrate layer 100, respectively. Accordingly, a distance between the touch circuit board and the touch sensor driving IC chip, and a distance between the circuit board 300 and the antenna driving IC chip may be decreased. Thereby, space efficiency may be improved and signal efficiency may be enhanced.

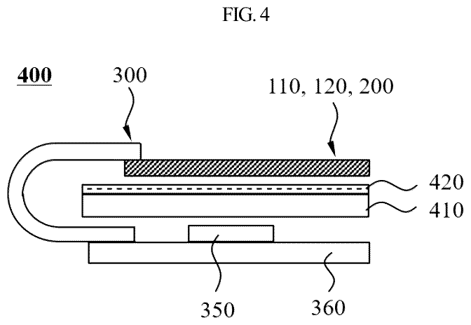

FIGS. 3 and 4 are a schematic plan view and a cross-sectional view illustrating an image display device according to exemplary embodiments, respectively.

FIG. 3 illustrates a front portion or a window surface of an image display device 400 manufactured in the form of, for example, a smart phone. The front surface of the image display device 400 may include a display area (DA) 430 and a non-display area (NDA) 440. The non-display area 440 may correspond to, for example, a light-shielding part or a bezel part of the image display device 400.

The sensor device according to exemplary embodiments may be disposed toward the front portion of the image display device 400, and for example, may be disposed on a display panel. In some embodiments, the sensor device may be attached to the display panel in the form of a film.

In some embodiments, the sensor device may be formed across the display area 430 and the non-display area 440 of the image display device 400.

In some embodiments, the active area AA of the sensor device may be overlapped with the display area 430. In one embodiment, the sensing electrodes 110 and 120 and/or the radiator 210 may be at least partially overlapped with the display area 430.

In some embodiments, the peripheral area PA of the sensor device may be overlapped with the non-display area 440. The traces 130 and 140 and/or the signal pad 230 may be at least partially overlapped with the non-display area 440. For example, a portion of the sensor device having the solid structure may be overlapped with the non-display area 440.

The sensor device may be powered or driven through the circuit board 300 and the touch circuit board. For the convenience of description, the touch circuit board is not shown in FIG. 4.

An antenna driving IC chip 350 may be mounted on the circuit board 300. As shown in FIG. 4, a relay circuit board 360 such as a rigid printed circuit board may be disposed between the circuit board 300 and the antenna driving IC chip 350. In one embodiment, the antenna driving IC chip 350 may be mounted directly on the circuit board 300.

The touch sensor driving IC chip may be mounted on the touch circuit board. For example, the relay circuit board 360 may be disposed between the touch circuit board and the touch sensor driving IC chip. For example, the antenna driving IC chip 350 and the touch sensor driving IC chip may be disposed on the same relay circuit board 360. In this case, the circuit board 300 and the touch circuit board may be connected together to one relay circuit board 360.

Referring to FIG. 4, the image display device 400 may include a display panel 410 and the above-described sensor device disposed on the display panel 410.

According to exemplary embodiments, an optical layer 420 may be further included on the display panel 410. For example, the optical layer 420 may be a polarizing layer including a polarizer or a polarizing plate.

The circuit board 300 and the touch circuit board (e.g., a flexible printed circuit board) may be disposed on the back portion of the image display device 400 by being bent along, for example, the side bending profile of the display panel 410, and may extend toward the relay circuit board 360 (e.g., a main board) on which the antenna driving IC chip 350 and the touch sensor driving IC chip are mounted.

The circuit board 300 and the relay circuit board 360 are bonded or connected to each other through a connector, such that power supply and antenna driving control to the antenna unit 200 may be performed by the antenna driving IC chip 350.

The touch circuit board and the relay circuit board 360 are bonded or connected to each other through the connector, such that power supply and touch signal transmission to the sensing electrodes 110 and 120 by the touch sensor driving IC chip may be performed.

What is claimed is:

1. A sensor device comprising:
sensing electrodes;
traces connected to the sensing electrodes;
an antenna unit comprising a radiator and a signal pad; and
a circuit board comprising a core layer, a first signal wiring disposed on one surface of the core layer and bonded to the signal pad, a second signal wiring disposed on the other surface of the core layer, and a via structure penetrating the core layer to electrically connect the first signal wiring and the second signal wiring, the via structure disposed between the signal pad and the traces in a planar direction.

2. The sensor device according to claim 1, wherein the sensing electrodes comprise first sensing electrodes arranged in a column direction, and second sensing electrodes arranged in a row direction.

3. The sensor device according to claim 2, wherein the sensing electrodes comprise a plurality of first sensing electrode columns each comprising first sensing electrodes, and
the traces comprise column traces connected to each of the plurality of first sensing electrode columns.

4. The sensor device according to claim 3, wherein the plurality of first sensing electrode columns comprise:
an antenna-sensing electrode column comprising a recess of a shape into which the radiator is inserted; and
a base sensing electrode column except for the antenna-sensing electrode column.

5. The sensor device according to claim 4, wherein the recess is formed at one end of the antenna-sensing electrode column, and the column traces extend from the other end of the antenna-sensing electrode column.

6. The sensor device according to claim 5, wherein the column traces comprise a first column trace extending from the other end of the antenna-sensing electrode column, and a second column trace extending from one end of the base sensing electrode column, and
the other end of the antenna-sensing electrode column faces the one end of the base sensing electrode column in the column direction.

7. The sensor device according to claim 2, wherein the sensing electrodes comprise a plurality of second sensing electrode rows each comprising second sensing electrodes, and
the traces comprise row traces connected to each of the plurality of second sensing electrode rows.

8. The sensor device according to claim 7, wherein the row traces comprise a first row trace extending from one end of the second sensing electrode row, and a second row trace extending from the other end of the second sensing electrode row.

9. The sensor device according to claim 1, wherein the sensing electrodes and the antenna unit are disposed in the same layer.

10. The sensor device according to claim 1, wherein the antenna unit and the traces are disposed in the same layer.

11. The sensor device according to claim 1, wherein the antenna unit further comprises a transmission line connecting the radiator and the signal pad.

12. The sensor device according to claim 1, wherein the second signal wiring and the traces are spaced apart from each other in a thickness direction with the core layer interposed therebetween.

13. The sensor device according to claim 1, further comprising touch sensor pads connected to one end of each of the traces, and
the other end of each of the traces is connected to the sensing electrodes.

14. An image display device comprising:
a display panel; and
the sensor device according to claim 1 arranged in the display panel.
